(19) United States
(12) Patent Application Publication
(10) Pub. No.: US 2013/0044571 A1
(43) Pub. Date: Feb. 21, 2013

(54) ELECTRONIC INSTRUMENT, STOPWATCH

(71) Applicant: Tomohiro IHASHI, Chiba-shi (JP)

(72) Inventor: Tomohiro IHASHI, Chiba-shi (JP)

(21) Appl. No.: 13/559,736

(22) Filed: Jul. 27, 2012

(30) Foreign Application Priority Data
Aug. 17, 2011 (JP) 2011-178449

(51) Int. Cl. G04B 47/06

(52) U.S. Cl. 368/10

(57) ABSTRACT

An acceleration sensor detects acceleration in a first direction and outputs a first signal. An acceleration sensor detects the acceleration in a second direction orthogonal to the first direction and outputs a second signal. An acceleration sensor detects acceleration in a third direction orthogonal to a plane uniquely specified by the first direction and the second direction, and outputs a third signal. A CPU performs time counting. The CPU acquires the first signal, the second signal, and the third signal, and determines the posture of the instrument on the basis of the average acceleration of movement of the first signal, the average acceleration of movement of the second signal, and the average acceleration of movement of the third signal. The CPU acquires a lap time or/and a split time when the posture of the instrument is determined to be a predetermined posture.

### 1. TECHNICAL FIELD

The present invention relates to an electronic instrument, a stopwatch.

### 2. DESCRIPTION OF THE RELATED ART

In the related art, there is a pedometer configured to detect the number of steps at the time of running or at the time of waking of a person who carries the pedometer by detecting body movements on the basis of walking using a body movement sensor such as an acceleration sensor and counting the detected body movements. By using a wristwatch provided with a pedometer as described above at the time of jogging, a traveling distance or a walking speed can be obtained on the basis of the number of steps during the travel or the length of stride input in advance.

In a case where the time counting with the wristwatch provided with a stopwatch function during the jogging or running, there is a problem in that switching operations during the running are troublesome. For example, the switching operations to be performed during the running include a start operation of the stopwatch, a stop operation of the stopwatch, and a lap time acquiring operation for counting a required time period in a mid section. In these operations, a technology to interpret the start of vibrations of walking or running as the start operation of the stopwatch and the stop of the vibrations of walking or running as the stop operation of the stopwatch is known (for example, see JP-A-62-223616). There is also a known technology to perform the lap time acquiring operation by tapping the watch (for example, see JP-A-1-270694).

However, the lap time, being counted during the running, cannot be acquired on the basis of the start of the vibrations or the stop of the vibrations. Also, when the lap time acquiring operation is performed by tapping the watch, the watch is worn on one hand and the watch is tapped by the other hand. Therefore, both hands need to be used for the operation as a consequence, and there is a problem in that the operation is complicated.

### SUMMARY

It is an aspect of the present application to provide a stopwatch which are capable of acquiring a lap time or/and a split time with a simple operation.

The application provides an electronic instrument including: a first acceleration sensor configured to detect acceleration in a first direction and output a first signal corresponding to the acceleration; a second acceleration sensor configured to detect the acceleration in a second direction orthogonal to the first direction and output a second signal corresponding to the acceleration; a third acceleration sensor configured to detect the acceleration in a third direction orthogonal to a plane uniquely specified by the first direction and the second direction and output a third signal corresponding to the acceleration; a timer unit configured to count time; a posture determining unit configured to acquire the first signal, the second signal, and the third signal, and determine the posture of the instrument on the basis of the average value of movement of the first signal, the average value of movement of the second signal, and the average value of movement of the third signal; and a control unit configured to acquire a lap time or/and a split time when the posture determining unit determines that the posture of the instrument is a predetermined posture.

The electronic instrument preferably includes a display unit configured to display a counted time value, and the predetermined posture is a posture in which the display unit is oriented toward eyesight of an operator.

The electronic instrument preferably includes a walking determining unit configured to acquire one of more signals from among the first signal, the second signal, and the third signal, and determine whether or not a user is walking using the acquired signal, and the control unit acquires the lap time or/and the split time when the walking determining unit determines that the user is walking and that the posture determining unit determines the posture of the instrument is the predetermined posture.

Preferably, the control unit acquires the lap time or/and the split time when the posture determining unit determines that the posture of the instrument is the predetermined posture continuously for a predetermined period.

Preferably, the control unit stores the lap time or/and the split time acquired immediately after the posture determining unit determines that the posture of the instrument is the predetermined posture temporarily, and, when the posture determining unit determines that the posture of the instrument is the predetermined posture continuously for the predetermined period, acquires the value stored temporarily as the lap time or/and the split time.

Preferably, a value obtained by subtracting the predetermined period from the lap time or/and the split time acquired immediately after the posture determining unit determines that the posture of the instrument is the predetermined posture continuously for the predetermined period is acquired as the lap time or/and the split time.

The electronic instrument preferably includes an audible notifier configured to output a sound, and the control unit causes the audible notifier to output the sound immediately after the posture determining unit determines that the posture of the instrument is the predetermined posture and then causes the audible notifier to output the sound immediately after the posture determining unit determines that the posture of the instrument is the predetermined posture continuously for the predetermined period.

Preferably, the sound that the audible notifier is caused to output immediately after the posture determining unit determines that the posture of the instrument is the predetermined posture is different from the sound that the audible notifier is caused to output immediately after the posture determining unit determines that the posture of the instrument is the predetermined posture continuously for the predetermined period.

Preferably, the control unit stops a lap time or/and the split time acquiring process when the posture determining unit determines that the posture of the instrument is the predetermined posture and then determines that the posture of the instrument is different posture from the predetermined posture before the predetermined period is elapsed.

Preferably, the predetermined period may be set arbitrarily.

The electronic instrument includes a display unit configured to display a counted time value, and when the control unit acquires the lap time or/and the split time, the control unit causes the display unit to display the lap time or/and the split time.

Preferably, whether or not the acquisition of the lap time or/and the split time by the control unit may be set arbitrarily.

The application provides a stopwatch including: a first acceleration sensor configured to detect an acceleration in a first direction and output a first signal corresponding to the acceleration; a second acceleration sensor configured to detect the acceleration in a second direction orthogonal to the first direction and output a second signal corresponding to the acceleration; a third acceleration sensor configured to detect the acceleration in a third direction orthogonal to a plane uniquely specified by the first direction and the second direction and output a third signal corresponding to the acceleration; a timer unit configured to count time; a posture determining unit configured to acquire the first signal, the second signal, and the third signal, and determine the posture of the instrument on the basis of the average value of movement of the first signal, the average value of movement of the second signal, and the average value of movement of the third signal; and a control unit configured to acquire a lap time or/and a split time when the posture determining unit determines that the posture of the instrument is a predetermined posture.

According to the application, the first acceleration sensor detects the acceleration in the first direction, and outputs the first signal corresponding to the acceleration. The second acceleration sensor detects the acceleration in the second direction orthogonal to the first direction, and outputs the second signal corresponding to the acceleration. The third acceleration sensor detects the acceleration in the third direction orthogonal to a plane uniquely specified by the first direction and the second direction, and outputs the third signal corresponding to the acceleration. The time counting unit performs time counting. The posture determining unit acquires the first signal, the second signal, and the third signal, and determines the posture of the instrument on the basis of the average value of movement of the first signal, the average value of movement of the second signal, and the average value of movement of the third signal. The control unit acquires a lap time or/and a split time when the posture determining unit determines that the posture of the instrument is the predetermined posture.

Accordingly, when the posture of the instrument becomes the predetermined posture, the lap time or/and the split time can be acquired, so that the lap time or/and the split time can be obtained with a simpler operation.

### BRIEF DESCRIPTION OF THE DRAWINGS

FIG. 1 is an appearance drawing showing an appearance of a stopwatch according to an embodiment of the invention;

FIG. 2 is a cross-sectional view showing a cross section of the stopwatch according to the embodiment;

FIG. 3 is a block diagram showing a configuration of the stopwatch according to the embodiment;

FIG. 4 is a schematic drawing showing orientations in an X-axis direction, a Y-axis direction, and an Z-axis direction in a case where the stopwatch is worn by a user in the embodiment;

FIG. 5 is a graph showing a magnitude of an average acceleration of movement in the X, Y, and Z-axis directions to be detected according to the posture of the stopwatch when the user is walking in the embodiment;

FIG. 6 is a graph showing a magnitude of a combined acceleration obtained by combining an acceleration in the X-axis direction, an acceleration in the Y-axis direction, and an acceleration in the Z-axis direction detected by the stopwatch when the user is walking in the embodiment;

FIG. 7 is a flowchart showing a process procedure of a candidate detecting process executed by the stopwatch in the embodiment;

FIG. 8 is a flowchart showing a process procedure of a pedometer counting process executed by the stopwatch in the embodiment;

FIG. 9 is a flowchart showing a process procedure of a posture determining process executed by the stopwatch in the embodiment;

FIG. 10 is a flowchart showing a process procedure of a time counting process executed by the stopwatch in the embodiment;

FIG. 11 is a flowchart showing a first example of the procedure of a lap acquiring process in the embodiment;

FIG. 12 is a flowchart showing a second example of the procedure of the lap acquiring process in the embodiment;

FIG. 13 is a flowchart showing a third example of the procedure of the lap acquiring process in the embodiment;

FIG. 14 is a flowchart showing a fourth example of the procedure of the lap acquiring process in the embodiment; and

FIG. 15 is a flowchart showing a fifth example of the procedure of the lap acquiring process in the embodiment.

### DESCRIPTION OF THE PREFERRED EMBODIMENTS

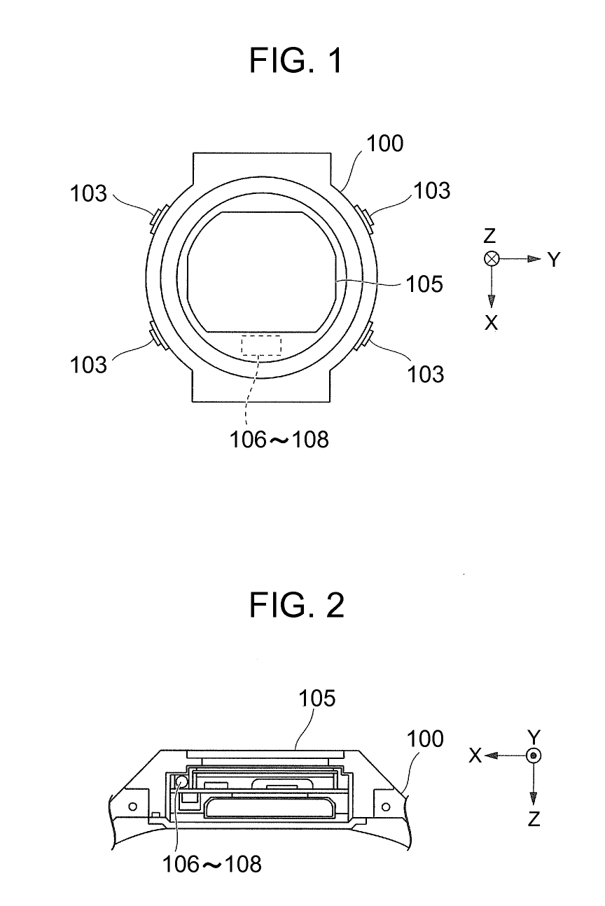

Referring now to the drawings, an embodiment of the invention will be described. In this embodiment, an example of a wristwatch-type stopwatch provided with a pedometer function will be described as an example of an electronic instrument. FIG. 1 is an appearance drawing showing an appearance of the stopwatch according to the embodiment of the invention. FIG. 2 is a cross-sectional view showing a cross section of the stopwatch according to the embodiment. In the example shown in FIG. 1 and FIG. 2, a stopwatch 100 includes a display 105 on an upper surface thereof, and an input unit 103 on a side surface thereof. The stopwatch 100 also includes acceleration sensors 106 to 108 in the interior thereof.

The display 105 includes a display surface, and a display such as measuring time is performed on the display surface. The input unit 103 accepts an input from a user of the stopwatch 100. The acceleration sensors 106 to 108 detect an X component, a Y component, and a Z component of orthogonal coordinate axes orthogonal to each other and output an acceleration signal of magnitudes corresponding to the accelerations of the respective components.

In this embodiment, the acceleration sensor 106 detects acceleration X in an X-axis direction. The acceleration sensor 107 detects an acceleration Y in a I-axis direction. The acceleration sensor 108 detects acceleration Z in a Z-axis direction. In this embodiment, a plane which is the same as the display surface of the display 105 provided with the stopwatch 100 is referred to as an XY plane and the direction perpendicular to the display surface of the display 105 is referred to as the Z-axis direction. The stopwatch 100 shows an example of the wristwatch-type stopwatch used by the user wearing on his or her wrist.

The acceleration sensors 106 to 108 may be, for example, an MEMS (Micro Electro Mechanical Systems) triaxial acceleration sensor or may be three single-axis acceleration sensors disposed in the three-axis directions orthogonal to each other.

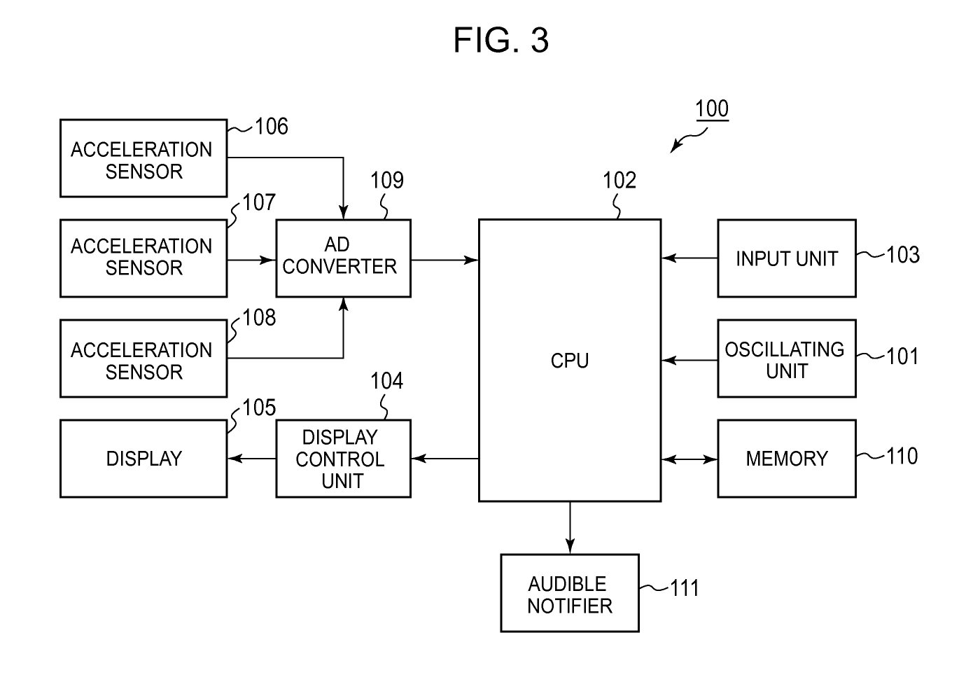

FIG. 3 is a block diagram showing a configuration of the stopwatch 100 according to the embodiment. In the illustrated example, the stopwatch 100 includes an oscillating unit 101, a CPU 102 (central processing unit, time counting unit, posture determining unit, control unit), the input unit 103, a display control unit 104, the display 105, the acceleration sensor 106 (first acceleration sensor), the acceleration sensor 107 (second acceleration sensor), the acceleration sensor 108 (third acceleration sensor), an AD converter 109, a memory 110, and an audible notifier 111.

The oscillating unit 101 generates a reference clock signal for the operation of the CPU 102. The CPU 102 performs a time counting process, a number-of-steps calculating process, a walking or running determining process for determine whether the user is walking or running, a determining process for determining the posture of the stopwatch 100, a lap time or/and split time acquiring process, and a control of respective electronic circuit elements which constitute a pedometer. The input unit 103 accepts an input of an instruction from the user. The display control unit 104 displays a counted time value, a lap time, a split time, time-of-day, and so on on the display 105 in response to a control signal from the CPU 102. The display 105 includes a liquid crystal display device (LCD), and displays the counted time value, the lap time, the split time, the time-of-day and so on.

The acceleration sensors 106 to 108 detect the X component, the Y component, and the Z component of the orthogonal coordinate axes orthogonal to each other and output the acceleration signal of magnitudes corresponding to the accelerations of the respective components. The memory 110 stores a program to be executed by the CPU 102 and data required in the course in which the respective portions of the stopwatch 100 perform the processes. In this embodiment, for example, the CPU 102 operates as the posture determining unit and the control unit of the invention.

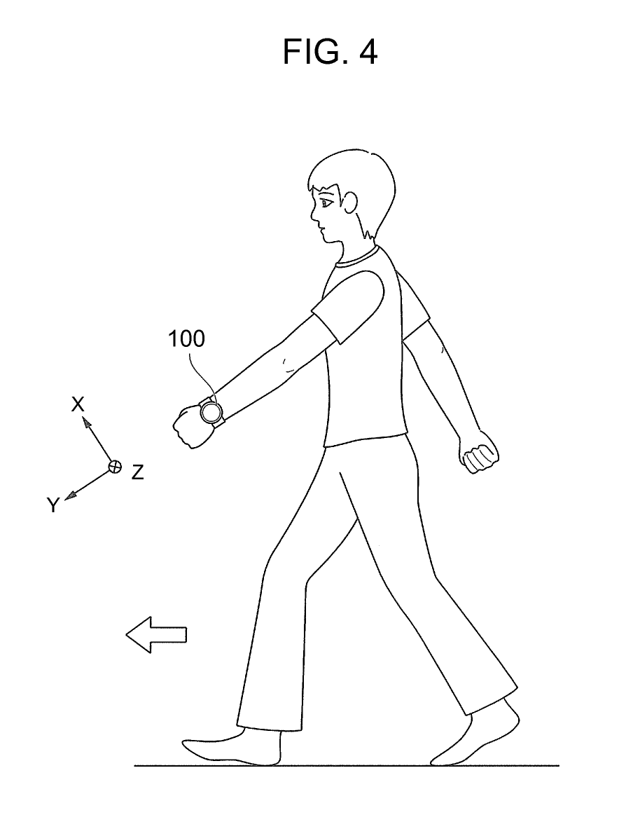

Subsequently, orientations in the X-axis direction, the Y-axis direction, and the Z-axis direction in a case where the stopwatch 100 is worn by the user will be described. FIG. 4 is a schematic drawing showing orientations in the X-axis direction, the Y-axis direction, and the Z-axis direction in the case where the stopwatch 100 is worn by the user. As illustrated, when the stopwatch 100 is worn on the wrist of the user, a direction from his or her elbow toward the back of his or her hand corresponds to the Y-axis direction, the direction perpendicular to the back of his or her hand corresponds to the Z-axis direction, and a direction perpendicular to a plane determined uniquely by the Y-axis direction and the Z-axis direction corresponds to the X-axis direction.

Subsequently, a magnitude of an average acceleration of movement in the X, Y, and Z-axis directions to be detected according to the posture of the stopwatch 100 when the user is walking while watching the display 105 will be described. Depending on the orientation of the display 105 of the stopwatch 100, the magnitude of the average acceleration of movement in the X, Y, and Z-axis directions vary. Therefore, whether or not the display 105 faces the face of the user (the direction of eyesight), that is, whether or not the user is walking or running while watching the display 105 is determined on the basis of the average acceleration of movement in the X, Y, and Z-axis directions in this embodiment.

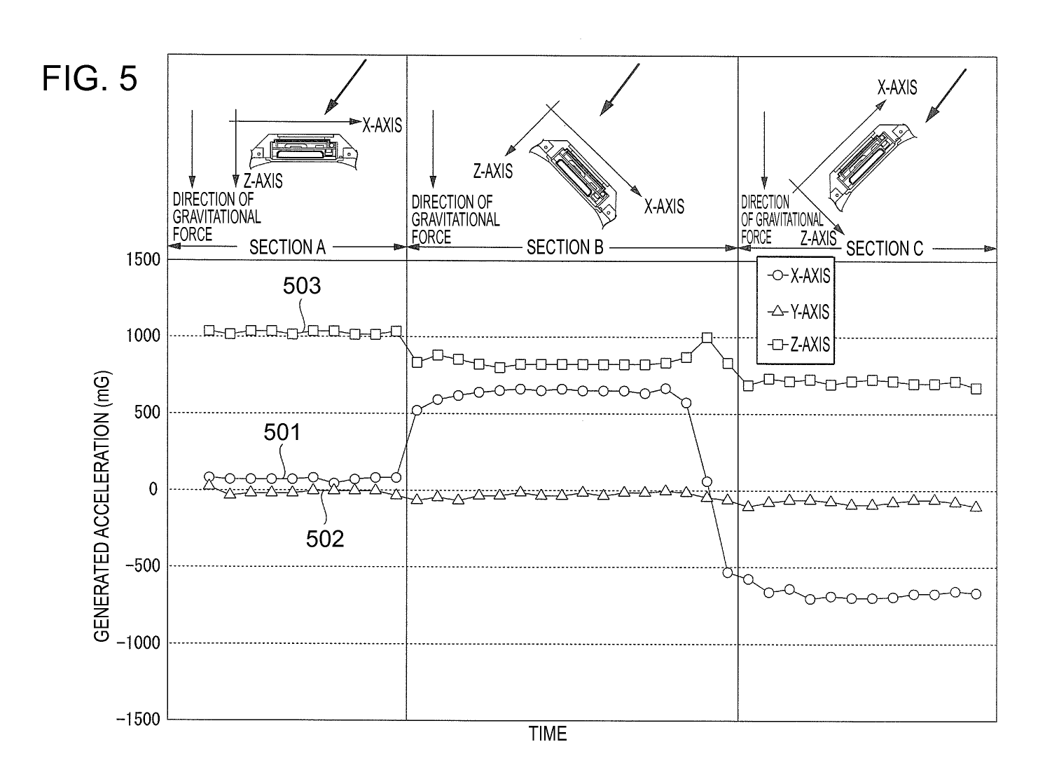

FIG. 5 is a graph showing the magnitude of the average acceleration of movement in the X, Y, and Z-axis directions to be detected according to the posture of the stopwatch 100 when the user is walking in this embodiment. In the illustrated example, the lateral axis indicates time and the vertical axis indicates the magnitude of the average acceleration of movement [mG] as an average of the acceleration of last two seconds. A line 501 indicates the magnitude of an average acceleration of movement X in the X-axis direction, a line 502 indicates the magnitude of an average acceleration of movement Y in the Y-axis direction, and a line 503 indicates the magnitude of an average acceleration of movement Z in the Z-axis direction.

A section A in FIG. 5 shows an acceleration detected by the stopwatch 100 in the posture where the Z-axis direction extends downward from above (the Z-axis direction is the same direction as the direction of the acceleration gravity), that is, when the user wears the stopwatch 100 on the left arm and walks with the display 105 in the horizontal state. In the illustrated example, the stopwatch 100 detects that the average acceleration of movement in the X-axis direction and the Y-axis direction is approximately 0 mG and the average acceleration of movement in the Z-axis direction is approximately 1000 mG. The posture of the stopwatch 100 in this case is referred to as a posture a.

A section B in FIG. 5 shows an acceleration detected by the stopwatch 100 in the posture where the X-axis direction and the Z-axis direction extend downward from above in the direction inclined by 45 degrees from the direction of the acceleration gravity, that is, when the user wears the stopwatch 100 on the left arm and walks with the display 105 inclined toward the face. In the illustrated example, the stopwatch 100 detects that the average acceleration of movement in the X-axis direction is approximately 620 mG, the average acceleration of movement in the Y-axis direction is approximately 0 mG, and the average acceleration of movement in the Z-axis direction is approximately 800 mG. The posture of the stopwatch 100 in this case is referred to as a posture b (predetermined posture, the posture when the display 105 is oriented in the direction of eyesight of the user, the posture watching the watch).

A section C in FIG. 5 shows an acceleration detected by the stopwatch 100 in the posture where the X-axis direction extends upward from below in the direction inclined by 45 degrees from the direction of the acceleration of gravity and the Z-axis direction extends downward from above in the direction inclined by 45 degrees from the direction of the acceleration gravity, that is, when the user wears the stopwatch 100 on the left arm and walks with the display 105 inclined in a direction opposite from the face. In the illustrated example, the stopwatch 100 detects that the average acceleration of movement in the X-axis direction is approximately −620 mG, the average acceleration of movement in the Y-axis direction is approximately 0 mG, and the average acceleration of movement in the Z-axis direction is approximately 800 mG. The posture of the stopwatch 100 in this case is referred to as a posture c.

From the graph described above, when the acceleration in the X-axis direction is equal to or higher than 200 mG, the acceleration in the Y-axis direction is from −500 mG to 500 mG inclusive, and the acceleration in the Z-axis direction is equal to or higher than 700 mG, it can be determined that the display 105 of the stopwatch 100 is oriented toward the face of the user, that is, the user is walking while watching the display 105.

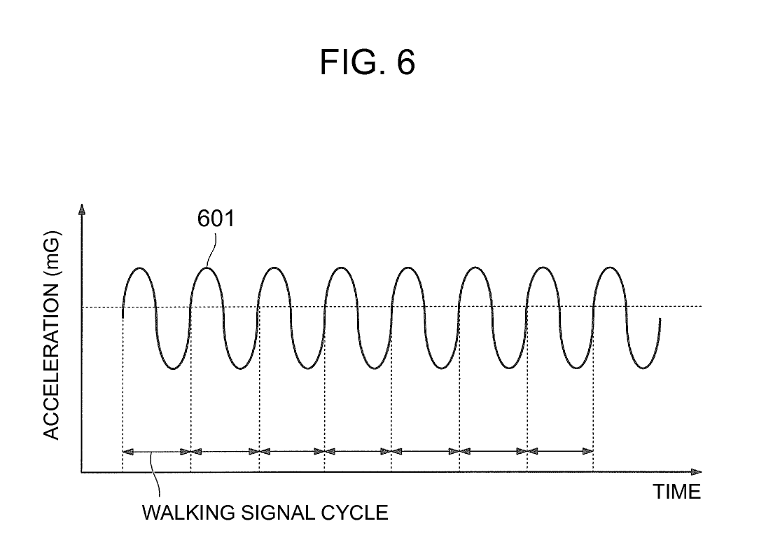

Subsequently, a magnitude of acceleration to be detected by the stopwatch 100 when the user is walking will be described. FIG. 6 is a graph showing a magnitude of combined acceleration obtained by combining the acceleration in the X-axis direction, the acceleration in the Y-axis direction, and the acceleration in the Z-axis direction detected by the stopwatch 100 when the user is walking in this embodiment. In the illustrated example, the lateral axis indicates time and the vertical axis indicates the magnitude of combined acceleration [mG]. A curve 601 indicates a magnitude of combined acceleration obtained by combining the acceleration in the X-axis direction, the acceleration in the Y-axis direction, and the acceleration in the Z-axis direction. One cycle of the curve 601 is determined as a walking signal cycle. The walking signal cycle is, although depending on the walking pitch of the user, smaller than one second.

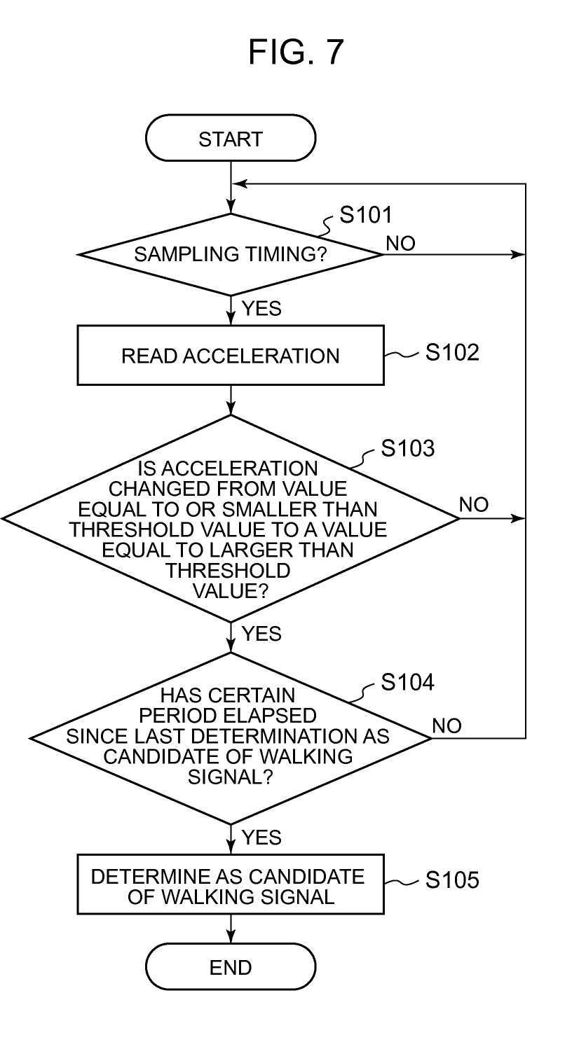

Subsequently, a process procedure of a candidate detecting process executed by the stopwatch 100 for detecting candidates of a walking signal will be described. FIG. 7 is a flowchart showing a process procedure of the candidate detecting process executed by the stopwatch 100 in this embodiment. The stopwatch 100 executes the candidate detecting process repeatedly. In the following description, an example in which the candidates of the walking signal are detected using a combined output obtained by combining outputs from the acceleration sensors 106 to 108 will be described. However, the candidates of the walking signal may be detected using one or more outputs from the outputs from the acceleration sensors 106 to 108.

(Step S101) The CPU 102 determines whether or not it is a timing (a sampling timing) to perform the processes from Step S102 onward. The procedure goes to Step S102 when the CPU 102 determines that it is the sampling timing, and in other cases, the process in Step S101 is executed again. For example, assuming that the sampling timing is 50 ms, the CPU 102 executes the process from Step S102 onward every 50 ms. In other words, intervals that the CPU 102 performs the processes from Step S102 onward (sampling intervals) are 50 ms. The sample timing is preferably set to 50 ms to 100 ms.

(Step S102) The CPU 102 acquires respective output values from the acceleration sensors 106, 107, and 108 at the sampling intervals converted into a digital signal by the AD converter 109 and calculates a combined output value. Subsequently, the procedure goes to the process in Step S103. For example, when the sampling timing is 50 ms, the AD converter 109 outputs the respective output values from the acceleration sensors 106, 107, and 108 at every 50 ms, and the CPU 102 acquires the respective output values from the acceleration sensors 106, 107, and 108 output by the AD converter 109 every 50 ms and calculates a combined output value.

(Step S103) The CPU 102 determines whether or not the combined output value of the acceleration sensors 106, 107, and 108 at the sampling intervals calculated in Step S102 is changed from a value equal to or lower than a threshold value to a value equal to or larger than a threshold value. When the CPU 102 determines that the combined output value of the acceleration sensors 106, 107, and 108 at the sampling intervals calculated in Step S102 is changed from the value equal to or smaller than the threshold value to the value equal to or larger than a threshold value, the procedure goes to the process in Step S104, and in other cases, the procedure goes back to the process in Step S101. For example, when the threshold value is 1200 mG and the combined output value of the acceleration sensors 106, 107, and 108 is changed from 1150 mG to 1250 mG, the CPU 102 determines that the combined output value of the acceleration sensors 106, 107, and 108 is changed to from the value equal to or smaller than the threshold value to the value equal to or larger than the threshold value.

(Step S104) The CPU 102 determines whether or not a certain period of time has elapsed since the last determination of the candidate of the walking signal. When the CPU 102 determines that a certain time (mask time) has elapsed since the last determination of the candidate of the walking signal, the procedure goes to the process in Step S105, and in other cases, the procedure goes back to the process in Step S101. The mask time may be configured to be determined arbitrarily depending on the environment.

(Step S105) The CPU 102 determines that the combined output value of the acceleration sensors 106, 107, and 108 calculated in Step S102 is a candidate of the walking signal. Subsequently, the candidate detecting process is terminated.

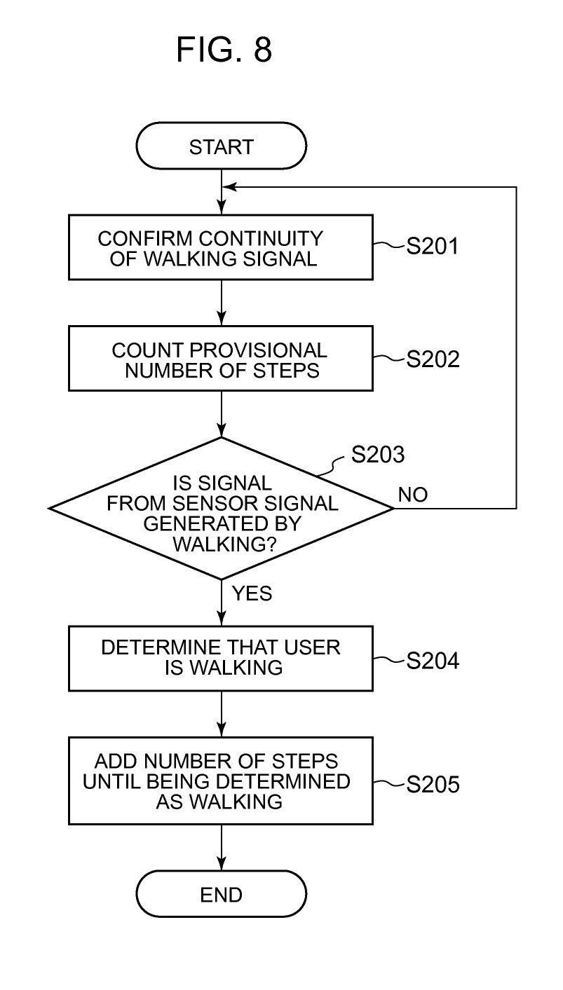

Subsequently, the process procedure of the number-of-steps counting process performed by the stopwatch 100 for counting the number of steps will be described. FIG. 8 is a flowchart showing the process procedure of the number-of-steps counting process executed by the stopwatch 100 in this embodiment. The stopwatch 100 executes the number-of-steps counting process repeatedly.

(Step S201) The CPU 102 determines whether or not the candidates of the waking signal detected by the candidate detecting process are continued (continuity is confirmed). Subsequently, the procedure goes to the process in Step S202. For example, when the candidates of the walking signal within one second intervals are detected by six times or more during six seconds, the candidates of the walking signal are determined to be continuous.

(Step S202) The CPU 102 counts the number of candidates of the walking signal detected in the detecting process after having added the number of steps in the process in previous Step S205 as a provisional number of steps. Subsequently, the procedure goes to the process in Step S203.

(Step S203) When the CPU 102 determines that the candidates of the walking signal are continuous in the process in Step S201, the CPU 102 determines that the output values from the acceleration sensors 106, 107, and 108 are signals generated by the waking. When the CPU 102 determines that the output values from the acceleration sensors 106, 107, and 108 are signals generated by the walking, the procedure goes to the process in Step S204, and in other cases, the procedure goes back to the process in Step S201.

(Step S204) The CPU 102 determines that the user is walking. Subsequently, the procedure goes to the process in Step S205.

(Step S205) The CPU 102 adds the provisional number of steps counted in Step S202 to the number of steps. Subsequently, the number-of-steps counting process is terminated.

Subsequently, the posture determining process for determining the posture of the stopwatch 100 will be described.

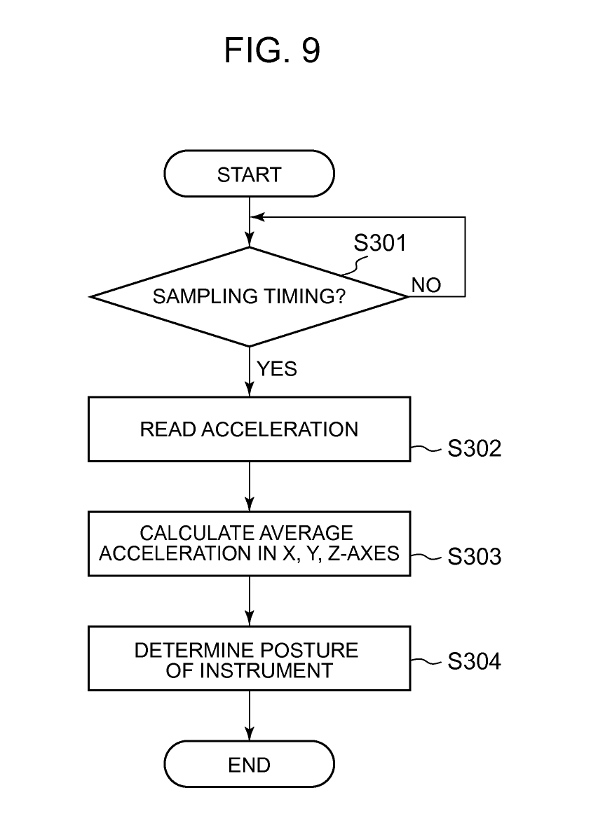

FIG. 9 is a flowchart showing a process procedure of the posture determining process executed by the stopwatch 100 in this embodiment. The stopwatch 100 executes the posture determining process repeatedly.

(Step S301) The CPU 102 determines whether or not it is a timing (a sampling timing) to perform the process from Step S302 onward. The procedure goes to the process in Step S302 when the CPU 102 determines that it is the sampling timing, and in other cases, the process in S301 is performed again. For example, assuming that the sampling timing is 50 ms, the CPU 102 executes the processes from Step S302 onward at every 50 ms. In other words, intervals that the CPU 102 performs the processes from Step S302 onward (sampling intervals) are 50 ms. The sample timing is preferably set to 50 ms to 100 ms.

(Step S302) The CPU 102 acquires outputs from the acceleration sensors 106, 107, and 108 during the past two seconds converted into the digital signal by the AD converter 109. Subsequently, the procedure goes to the process in Step S303. For example, when the AD converter 109 outputs the output values from the acceleration sensors 106, 107, and 108 every 50 ms, the CPU 102 acquires forty output values from the acceleration sensor 106, forty output values from the acceleration sensor 107, and forty output values from the acceleration sensor 108 output by the AD converter 109 for the last two seconds.

In this embodiment, description will be given using an example in which the outputs from the acceleration sensors 106, 107, and 108 during past two seconds are acquired. However, the invention is not limited thereto, and arbitrary period may be employed. It is also possible to change the period during which the outputs from the acceleration sensors 106, 107, and 108 are acquired according to the walking pitches. For example, it is possible to acquire the outputs from the acceleration sensors 106, 107, and 108 during past two seconds since the outputs from the acceleration sensors 106, 107, and 108 are approximately 2 Hz during walking and to acquire the outputs from the acceleration sensors 106, 107, and 108 during past one second since the outputs from the acceleration sensors 106, 107, and 108 are approximately 3 Hz during running.

(Step S303) The CPU 102 calculates an average value of the output values from the acceleration sensor 106 during past two seconds (the average acceleration of movement in the X-axis direction), an average value of the output values from the acceleration sensor 107 during past two seconds (the average acceleration of movement in the Y-axis direction), and an average value of the output values from the acceleration sensor 108 during past two seconds (the average acceleration of movement in the Z-axis direction). Subsequently, the procedure goes to the process in Step S304.

(Step S304) The CPU 102 determines whether or not the display 105 of the stopwatch 100 is oriented toward the face of the user (whether or not the stopwatch 100 is in the posture b) on the basis of the average acceleration of movement in the X-axis direction, the average acceleration of movement in the Y-axis direction, and the average acceleration of movement in the Z-axis direction calculated in Step S303. Subsequently, the posture determining process is terminated. The relationship among the average acceleration of movement in the X-axis direction, the average acceleration of movement in the Y-axis direction, the average acceleration of movement in the Z-axis direction, and the posture of the stopwatch 100 is as described with reference to FIG. 5.

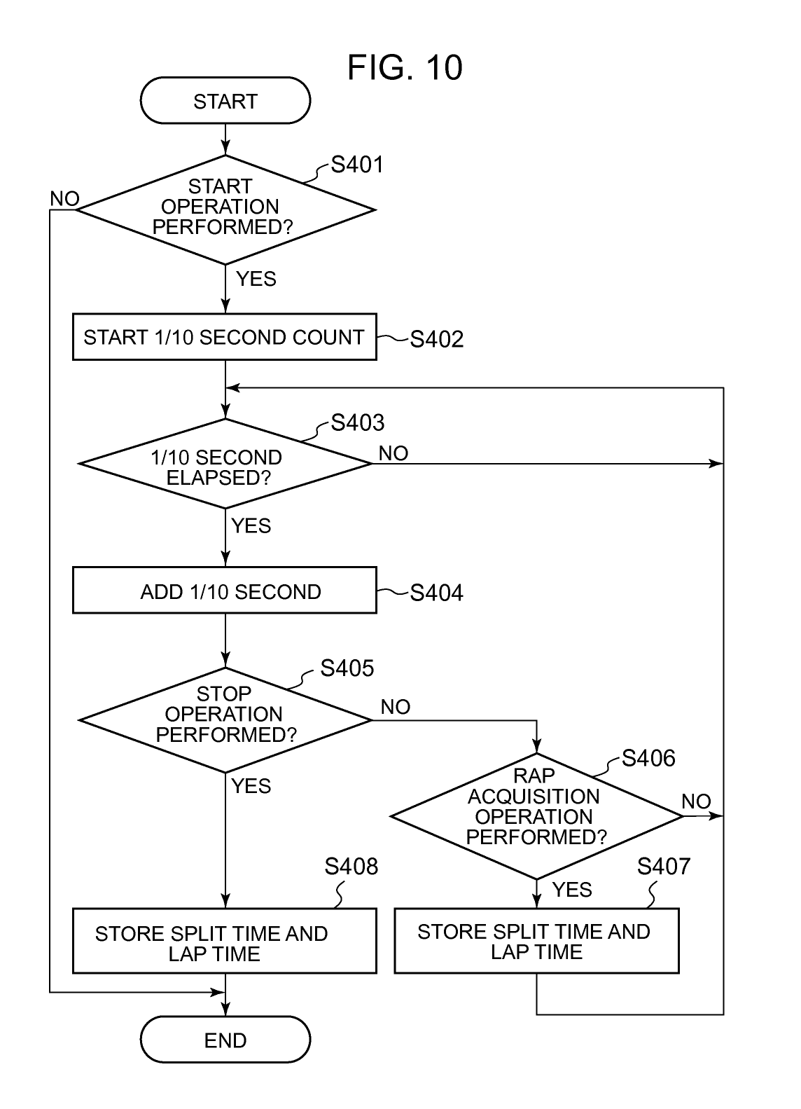

Subsequently, the time counting process of the stopwatch 100 will be described. FIG. 10 is a flowchart showing a process procedure of the time counting process executed by the stopwatch 100 in this embodiment. The stopwatch 100 executes the time counting process repeatedly. Although the acquisition of the lap time will be described below, the invention is not limited thereto, and the split time may be acquired instead of the lap time, and even both of the lap time and the split time may be acquired.

(Step S401) When an operator starts counting, the operator operates the input unit 103 and inputs an instruction of “START”. The CPU 102 determines whether or not the input of “START” which instructs the start of time counting is accepted by the input unit 103. When the CPU 102 determines that the input of “START” is accepted, the procedure goes to the process in Step S402, and in other cases, the process is terminated.

(Step S402) The CPU 102 starts counting of 1/10 second. Subsequently, the procedure goes to the process in Step S403.

(Step S403) The CPU 102 determines whether or not 1/10 second has elapsed since the counting of 1/10 is started in the process in Step S402. When the CPU 102 determines that 1/10 second has elapsed since the counting of 1/10 second is started in the process in Step S402, the procedure goes to the process in Step S404, and in other cases, the process in Step S403 is executed again.

(Step S404) The CPU 102 adds 1/10 second to the counted time. Subsequently, the procedure goes to the process in Step S405.

(Step S405) When the operator terminates counting, the operator operates the input unit 103 and inputs an instruction of “STOP”. The CPU 102 determines whether or not the input of “STOP” which instructs the termination of time counting is accepted by the input unit 103. When the CPU 102 determines that the input of “STOP” is accepted, the procedure goes to the process in Step S408, and in other cases, the procedure goes to the process in Step S406.

(Step S406) The CPU 102 performs the lap acquiring process. More specifically, when the CPU 102 determines that a lap acquiring operation is performed, the lap time is acquired and the procedure goes to the process in Step S407, and in other cases, the procedure goes back to the process in Step S403. Detailed procedure of the lap acquiring process will be described later.

(Step S407) The CPU 102 stores the lap time acquired in the process in Step S406 in the memory 110. Subsequently, the procedure goes back to the process in Step S403.

(Step S408) The CPU 102 determines the period from the start of time counting in the process in Step S401 until the input of “STOP” is accepted in the process in Step S405 as a lap time. When the process in the Step S407 is performed once or more, the CPU 102 determines the period from when the lap time is finally acquired until when the input of “STOP” is accepted as a lap time. Also, the CPU 102 determines the period from the start of time counting in the process in Step S401 until the input of “STOP” is accepted in the process in Step S402 as a total time. Subsequently, the CPU 102 stores the determined lap time and total time in the memory 110. Subsequently, the process is terminated.

Subsequently, the procedure of the lap acquiring process in Step S406 will be described. Five examples of procedures of the lap acquiring process will be described below in order.

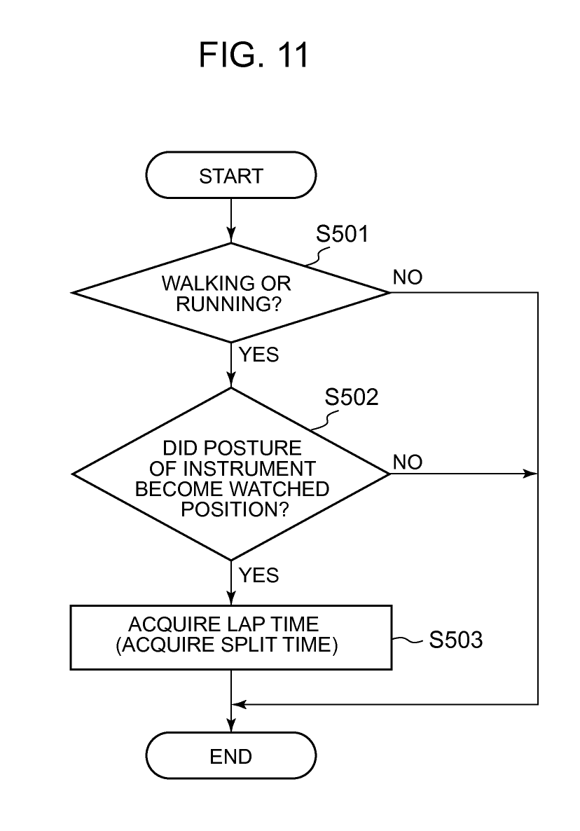

FIG. 11 is a flowchart showing a first example of the procedure of a lap acquiring process in the embodiment.

(Step S501) The CPU 102 determines whether or not the user is walking or running. When the CPU 102 determines that the user is walking or running, the procedure goes to the process in Step S502, and in other cases, the process is terminated and the procedure goes back to the process in Step S403 in FIG. 10. The process performed by the CPU 102 for determining whether or not the user is walking or running is the same process as the process in Step S201 to Step S204 in FIG. 8 for example.

(Step S502) When the operator acquires the lap time, the operator faces the display 105 of the stopwatch 100. With this operation, the operator inputs an instruction of the lap time acquisition to the stopwatch 100. The CPU 102 acquires the result of posture determining process, and determines whether or not the display 105 of the stopwatch 100 is oriented toward the face of the operator (whether or not the posture of the instrument is in a watched position). When the CPU 102 determines that the display 105 of the stopwatch 100 is oriented toward the face of the operator, the CPU 102 determines that the instruction of the lap time acquisition is input and the procedure goes to the process in Step S503, and in other cases, the process is terminated and the procedure goes back to the process in Step S403 in FIG. 10.

(Step S503) The CPU 102 determines the period from the start of time counting in the process in Step S401 in FIG. 10 until when the determination that the input of the instruction of the lap time acquisition is input in the process in Step S502 and acquires the same. When the input of the instruction of the lap time acquisition is determined twice or more, the CPU 102 determines the period from when the input of the instruction of the lap time acquisition for the second last time is determined until when the input of the instruction of the lap time acquisition for the last time is determined as the lap time and acquires the same. Subsequently, the CPU 102 terminates the process, and the procedure goes back to the process in Step S903 in FIG. 10.

From the procedure described above, the stopwatch 100 acquires the lap time when the display 105 is oriented toward the face of the operator. Accordingly, the operator is capable of acquiring the lap time with a simpler operation.

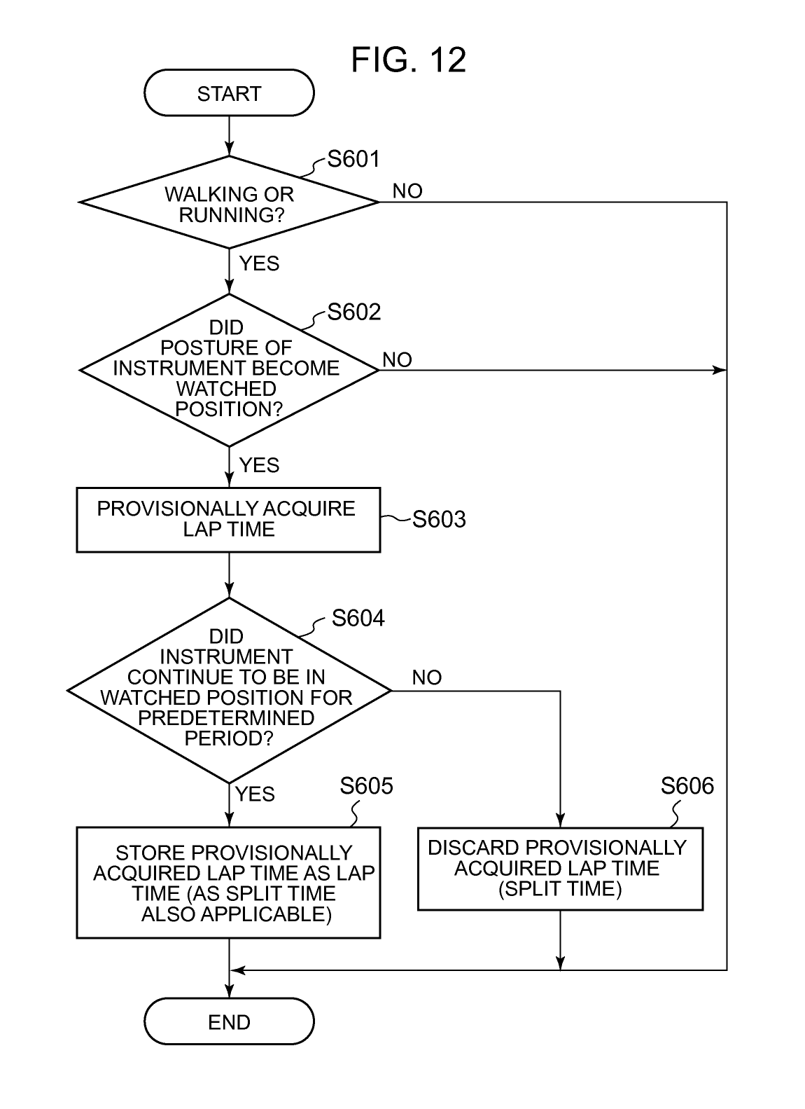

FIG. 12 is a flowchart showing a second example of the procedure of the lap acquiring process in the embodiment. The processes from Step S601 to Step S602 are the same as the processes from Step S501 to Step S502.

(Step S603) The CPU 102 determines the period from the start of time counting in the process in Step S401 in FIG. 10 until when the determination that the instruction of the lap time acquisition is input in the process in Step S406 as a provisional lap time and acquires the same. When the lap time is acquired in the past, the CPU 102 determines the period from the lap time acquired for the last time until when the determination that the instruction of the lap time acquisition is input in the process in Step S406 as a provisional lap time and acquires the same. Subsequently, the procedure goes to the process in Step S604.

(Step S604) The CPU 102 determines whether or not the display 105 of the stopwatch 100 is oriented toward the face of the operator for a predetermined period from when the display 105 of the stopwatch 100 is determined to be oriented toward the face of the operator (the posture of the instrument is in a watched position) in the process in Step S602. When the CPU 102 determines that the display 105 of the stopwatch 100 is oriented toward the face of the operator for the predetermined period, the procedure goes to the process in Step S605, and in other cases, the procedure goes to the process in Step S606. The predetermined period may be fixed in advance or may be configured to be set arbitrarily.

(Step S605) The CPU 102 determines the provisional lap time acquired in the process in Step S603 as a lap time and acquires the same. Subsequently, the process is terminated and the procedure goes back to the process in Step S403 in FIG. 10.

(Step S606) The CPU 102 discards the provisional lap time acquired in the process in Step S603. Subsequently, the process is terminated and the procedure goes back to the process in Step S403 in FIG. 10.

With the procedure described above, the stopwatch 100 acquires the lap time when the display 105 is oriented toward the face of the operator for the predetermined period. Accordingly, the operator is capable of acquiring the lap time with a simpler operation. Since the stopwatch 100 does not acquire the lap time when the display 105 is oriented toward the face of the operator only for a moment, acquisition of the lap time which is not expected by the operator can be prevented.

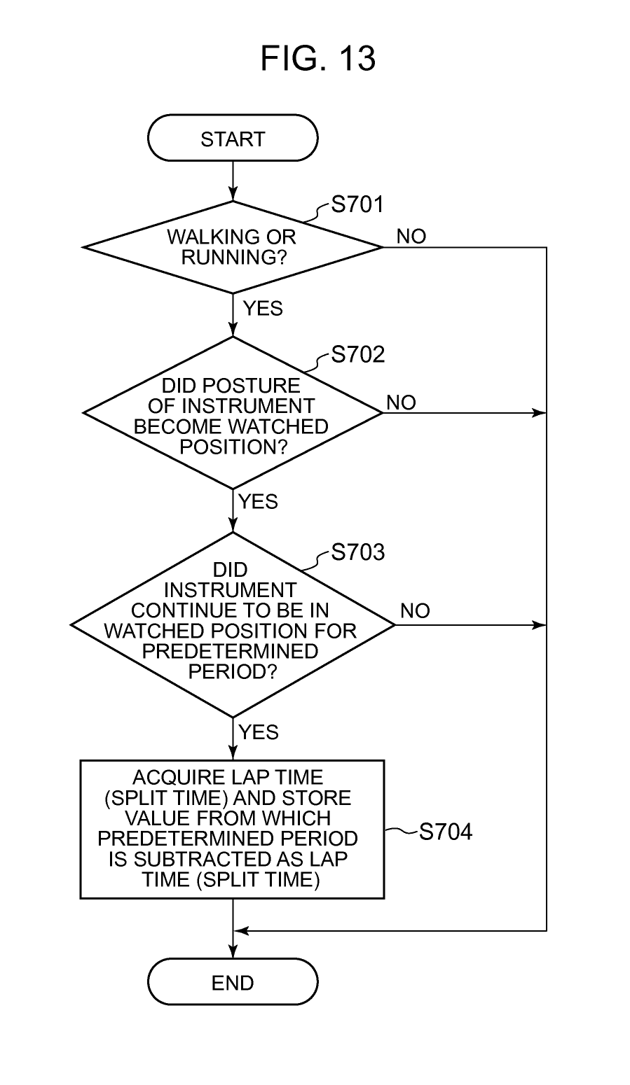

FIG. 13 is a flowchart showing a third example of the procedure of the lap acquiring process in the embodiment. The processes from Step S701 to Step S702 are the same as the processes from Step S601 to Step S602.

(Step S703) The CPU 102 determines whether or not the display 105 of the stopwatch 100 is oriented toward the face of the operator for a predetermined period from when the display 105 of the stopwatch 100 is determined to be oriented toward the face of the operator (the posture of the instrument is in a watched position) in the process in Step S702. When the CPU 102 determines that the display 105 of the stopwatch 100 is in a state of being still oriented toward the face of the operator for the predetermined period, the CPU 102 determines that the instruction of the lap time acquisition is input and the procedure goes to the process in Step S704, and in other cases, the process is terminated and the procedure goes back to the process in Step S403 in FIG. 10. The predetermined period may be fixed in advance or may be configured to be set arbitrarily.

(Step S704) The CPU 102 determines the period from the start of time counting in the process in Step S401 in FIG. 10 until when the determination that the instruction of the lap time acquisition is input in the process in Step S703 as a provisional lap time, and determines the value obtained by subtracting the predetermined time from the provisional lap time as the lap time and acquires the same. When the lap time is acquired in the past, the CPU 102 determines the period from the lap time acquired for the last time until when the determination that the instruction of the lap time acquisition is input in the process in Step S703 as a provisional lap time, and determines the value obtained by subtracting the predetermined time from the provisional lap time as the lap time and acquires the same. Subsequently, the procedure goes back to the process in Step S403 in FIG. 10.

With the procedure described above, the stopwatch 100 acquires the lap time when the display 105 is oriented toward the face of the operator for the predetermined period. Accordingly, the operator is capable of acquiring the lap time with a simpler operation. Since the stopwatch 100 does not acquire the lap time when the display 105 is oriented toward the face of the operator only for a moment, acquisition of the lap time which is not expected by the operator can be prevented.

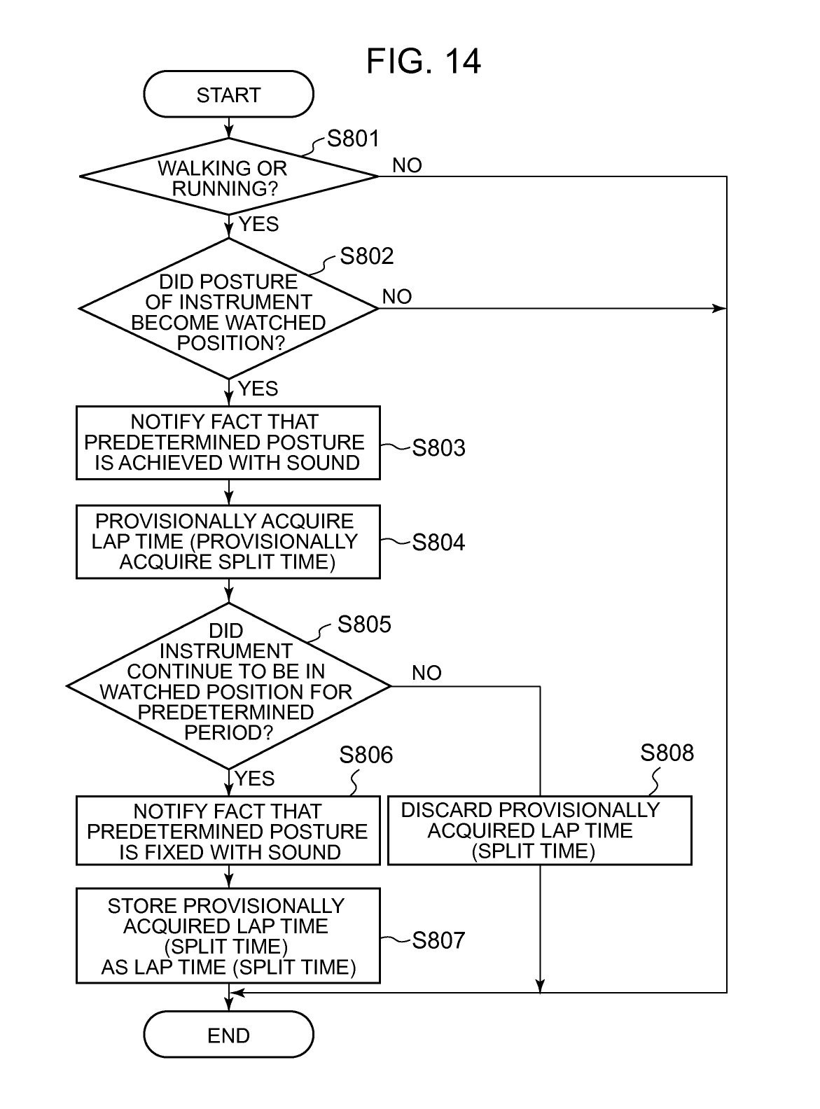

FIG. 14 is a flowchart showing a fourth example of the procedure of the lap acquiring process in the embodiment. The processes from Step S801 to Step S802 are the same as the processes from Step S601 to Step S602.

(Step S803) The CPU 102 controls an audible notifier 111 to output a sound indicating that the display 105 of the stopwatch 100 takes a posture oriented toward the face of the operator (predetermined posture). Subsequently, the procedure goes to the process in Step S804.

(Step S804) The CPU 102 determines the period from the start of time counting in the process in Step S401 in FIG. 10 until when the determination that the instruction of the lap time acquisition is input in the process in Step S802 and acquires the same. When the lap time is acquired in the past, the CPU 102 determines the period from the lap time acquired for the last time until when the determination that the instruction of the lap time acquisition is input in the process in Step S802 and acquires the same. Subsequently, the procedure goes to the process in Step S805.

(Step S805) The CPU 102 determines whether or not the display 105 of the stopwatch 100 is oriented toward the face of the operator for a predetermined period from when the display 105 of the stopwatch 100 is determined to be oriented toward the face of the operator (the posture of the instrument is in a watched position) in the process in Step S802. When the CPU 102 determines that the display 105 of the stopwatch 100 is oriented toward the face of the operator for the predetermined period, the procedure goes to the process in Step S806, and in other cases, the procedure goes to the process in Step S808. The predetermined period may be fixed in advance or may be configured to be set arbitrarily.

(Step S806) The CPU 102 controls the audible notifier 111 to output a sound indicating that the display 105 of the stopwatch 100 is kept in the posture oriented toward the face of the operator for a predetermined period (predetermined posture is fixed). Subsequently, the procedure goes to the process in Step S807.

The processes from Step S807 to Step S808 are the same as the processes from Step S605 to Step S606.

With the procedure described above, the stopwatch 100 acquires the lap time when the display 105 is oriented toward the face of the operator for the predetermined period. Accordingly, the operator is capable of acquiring the lap time with a simpler operation. Since the stopwatch 100 does not acquire the lap time when the display 105 is oriented toward the face of the operator only for a moment, acquisition of the lap time which is not expected by the operator can be prevented. The stopwatch 100 outputs a sound when the watched position is achieved, and when the watched position is continued for a predetermined period. Therefore, the operator is capable of clearly figuring out the fact that the lap acquiring operation is performed.

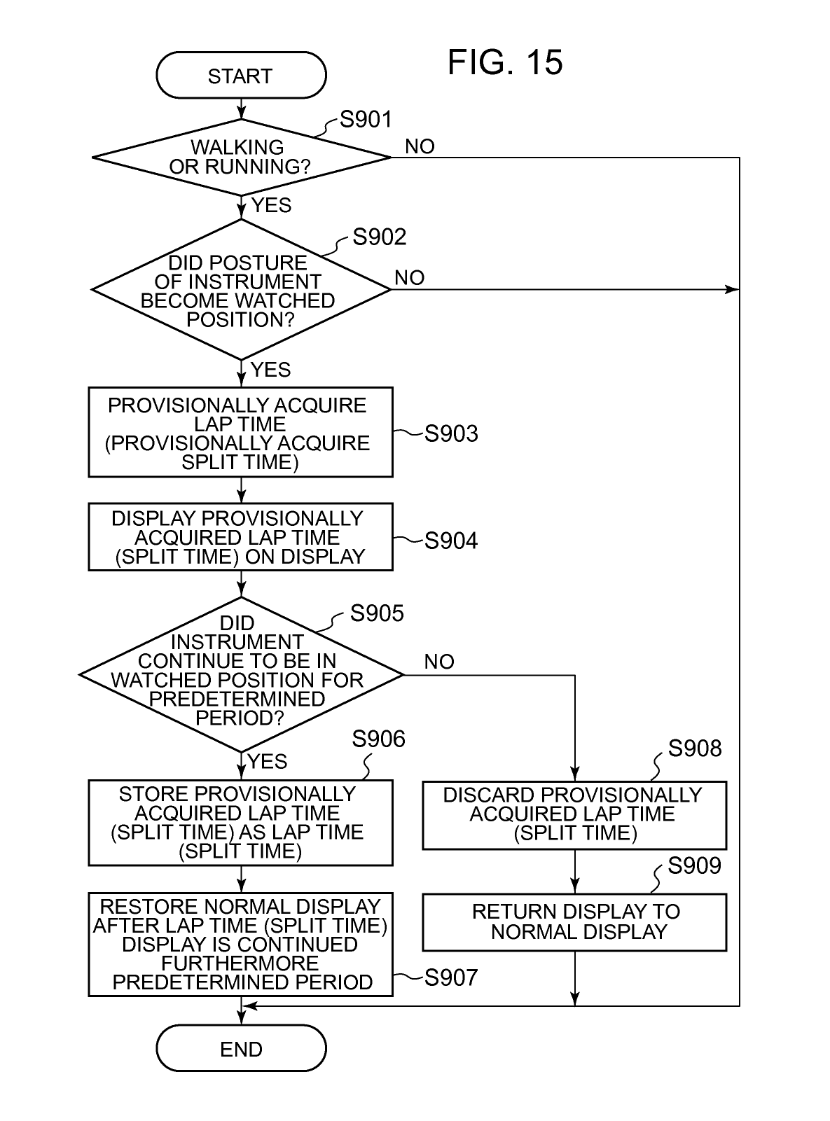

FIG. 15 is a flowchart showing a fifth example of the procedure of the lap acquiring process in the embodiment. The processes from Step S901 to Step S903 are the same as the processes from Step S601 to Step S603.

(Step S904) The CPU 102 controls the display control unit 104 to cause the display 105 to display the provisional lap time acquired in the process in Step S903. Subsequently, the procedure goes to the process in Step S905.

(Step S905) The CPU 102 determines whether or not the display 105 of the stopwatch 100 is oriented toward the face of the operator for a predetermined period from when the display 105 of the stopwatch 100 is determined to be oriented toward the face of the operator (the posture of the instrument is in a watched position) in the process in Step S902. When the CPU 102 determines that the display 105 of the stopwatch 100 is oriented toward the face of the operator for the predetermined period, the procedure goes to the process in Step S906, and in other cases, the procedure goes to the process in Step S908. The predetermined period may be fixed in advance or may be configured to be set arbitrarily.

(Step S906) The CPU 102 determines the provisional lap time acquired in the process in Step S903 as a lap time and acquires the same. Subsequently, the procedure goes to the process in Step S907.

(Step S907) The CPU 102 controls the display control unit 104 to cause the display 105 to display the lap time acquired in the process in Step S906 for a certain period. Subsequently, the CPU 102 controls the display control unit 104 to restore the display of the display 105 to the normal display, and the procedure goes back to the process in Step S403 in FIG. 10.

(Step S908) The CPU 102 discards the provisional lap time acquired in the process in Step S903. Subsequently, the procedure goes to the process in Step S909.

(Step S909) The CPU 102 controls the display control unit 104 to restore the display of the display 105 to the normal display, and the procedure goes back to the process in Step S403 in FIG. 10.

From the procedure described above, the stopwatch 100 acquires the lap time when the display 105 is oriented toward the face of the operator for the predetermined period. Accordingly, the operator is capable of acquiring the lap time with a simpler operation. Since the stopwatch 100 does not acquire the lap time when the display 105 is oriented toward the face of the operator only for a moment, acquisition of the lap time which is not expected by the operator can be prevented. The stopwatch 100 displays the provisional lap time on the display 105 when the watched position is achieved, and causes the display 105 to display the lap time when watched position is continued for a predetermined period. Therefore, the operator is capable of figuring out the lap time with a simple operation.

The entire or part of the functions of the respective components provided in the stopwatch 100 in the embodiment described above may be realized by recording a program for realizing these functions in a computer readable recording medium, and causing a computer system to read the program recorded in the recording program and executing the program. The term “computer system” described here includes hardware such as OS or peripheral equipment.

The “computer readable recording medium” means portable media such as flexible disks, magneto-optic disks, ROMs, and CD-ROMs, and memory devices such as hard disk integrated in the computer system. Also, the term “computer readable recording medium” may include those which hold the program dynamically for a short time like networks such as internet, or communication lines used for transmitting the program via a communication network such as telephone lines, and those which hold the program for a certain period such as a volatile memory in the interior of the computer system which becomes a server or a client in that case. The above-described program may be those which realize part of the above-described functions, and further may be those which can realize the above-describe functions in combination with the program already recorded in the computer system.

The invention is not limited to the embodiments described above, and various modifications may be made without departing the scope of the invention. For example, the wristwatch-type stopwatch having the pedometer function as shown in FIG. 1 has been described as an example of the electronic instrument in the embodiment described above. However, the invention is not limited thereto, and any types of electronic instruments may be applied as long as it is the electronic instrument used by being worn on the arm of the user.

What is claimed is:

1. An electronic instrument comprising:
a first acceleration sensor configured to detect acceleration in a first direction and output a first signal corresponding to the acceleration;
a second acceleration sensor configured to detect the acceleration in a second direction orthogonal to the first direction and output a second signal corresponding to the acceleration;
a third acceleration sensor configured to detect the acceleration in a third direction orthogonal to a plane uniquely specified by the first direction and the second direction and output a third signal corresponding to the acceleration;
a timer unit configured to count time;
a posture determining unit configured to acquire the first signal, the second signal, and the third signal, and determine the posture of the instrument on the basis of the average value of movement of the first signal, the average value of movement of the second signal, and the average value of movement of the third signal; and
a control unit configured to acquire a lap time or/and a split time when the posture determining unit determines that the posture of the instrument is a predetermined posture.

2. The electronic instrument according to claim 1, comprising:
a display unit configured to display a counted time value,
wherein the predetermined posture is a posture in which the display unit is oriented toward eyesight of an operator.

3. The electronic instrument according to claim 1, comprising:
a walking determining unit configured to acquire one of more signals from among the first signal, the second signal, and the third signal, and determine whether or not a user is walking using the acquired signal,
wherein the control unit acquires the lap time or/and the split time when the walking determining unit determines that the user is walking and the posture determining unit determines that the posture of the instrument is the predetermined posture.

4. The electronic instrument according to claim 2, comprising:
a walking determining unit configured to acquire one of more signals from among the first signal, the second signal, and the third signal, and determine whether or not a user is walking using the acquired signal,
wherein the control unit acquires the lap time or/and the split time when the walking determining unit determines that the user is walking and the posture determining unit determines that the posture of the instrument is the predetermined posture.

5. The electronic instrument according to claim 1, wherein the control unit acquires the lap time or/and the split time when the posture determining unit determines that the posture of the instrument is the predetermined posture continuously for a predetermined period.

6. The electronic instrument according to claim 2, wherein the control unit acquires the lap time or/and the split time when the posture determining unit determines that the posture of the instrument is the predetermined posture continuously for a predetermined period.

7. The electronic instrument according to claim 3, wherein the control unit acquires the lap time or/and the split time when the posture determining unit determines that the posture of the instrument is the predetermined posture continuously for a predetermined period.

8. The electronic instrument according to claim 4, wherein the control unit acquires the lap time or/and the split time when the posture determining unit determines that the posture of the instrument is the predetermined posture continuously for a predetermined period.

9. The electronic instrument according to claim 5, wherein the control unit stores the lap time or/and the split time acquired immediately after the posture determining unit determines that the posture of the instrument is the predetermined posture temporarily, and, when the posture determining unit determines that the posture of the instrument is the predetermined posture continuously for the predetermined period, acquires the value stored temporarily as the lap time or/and the split time.

10. The electronic instrument according to claim 6, wherein the control unit stores the lap time or/and the split time acquired immediately after the posture determining unit determines that the posture of the instrument is the predetermined posture temporarily, and, when the posture determining unit determines that the posture of the instrument is the predetermined posture continuously for the predetermined period, acquires the value stored temporarily as the lap time or/and the split time.

11. The electronic instrument according to claim 7, wherein the control unit stores the lap time or/and the split time acquired immediately after the posture determining unit determines that the posture of the instrument is the predetermined posture temporarily, and, when the posture determining unit determines that the posture of the instrument is the predetermined posture continuously for the predetermined period, acquires the value stored temporarily as the lap time or/and the split time.

12. The electronic instrument according to claim 8, wherein the control unit stores the lap time or/and the split time acquired immediately after the posture determining unit determines that the posture of the instrument is the predetermined posture temporarily, and, when the posture determining unit determines that the posture of the instrument is the predetermined posture continuously for the predetermined period, acquires the value stored temporarily as the lap time or/and the split time.

13. The electronic instrument according to claim 5, wherein a value obtained by subtracting the predetermined period from the lap time or/and the split time acquired immediately after the posture determining unit determines that the posture of the instrument is the predetermined posture continuously for the predetermined period is acquired as the lap time or/and the split time.

14. The electronic instrument according to claim 5, comprising:
an audible notifier configured to output a sound,
wherein the control unit causes the audible notifier to output the sound immediately after the posture determining unit determines that the posture of the instrument is the predetermined posture and then causes the audible notifier to output the sound immediately after the posture determining unit determines that the posture of the instrument is the predetermined posture continuously for the predetermined period.

15. The electronic instrument according to claim 14, wherein the sound that the audible notifier is caused to output immediately after the posture determining unit determines that the posture of the instrument is the predetermined posture is different from the sound that the audible notifier is caused to output immediately after the posture determining unit determines that the posture of the instrument is the predetermined posture continuously for the predetermined period.

16. The electronic instrument according to claim 5, wherein the control unit stops a lap time or/and the split time acquiring process when the posture determining unit determines that the posture of the instrument is the predetermined posture and then determines that the posture of the instrument is different posture from the predetermined posture before the predetermined period is elapsed.

17. The electronic instrument according to claim 5, wherein the predetermined period may be set arbitrarily.

18. The electronic instrument according to claim 1, comprising:
a display unit configured to display a counted time value, wherein
when the control unit acquires the lap time or/and the split time, the control unit causes the display unit to display the lap time or/and the split time.

19. The electronic instrument according to claim 1, wherein whether or not the acquisition of the lap time or/and the split time by the control unit may be set arbitrarily.

20. A stopwatch comprising:
a first acceleration sensor configured to detect acceleration in a first direction and output a first signal corresponding to the acceleration;
a second acceleration sensor configured to detect the acceleration in a second direction orthogonal to the first direction and output a second signal corresponding to the acceleration;
a third acceleration sensor configured to detect the acceleration in a third direction orthogonal to a plane uniquely specified by the first direction and the second direction and output a third signal corresponding to the acceleration;
a timer unit configured to count time;
a posture determining unit configured to acquire the first signal, the second signal, and the third signal, and determine the posture of the instrument on the basis of the average value of movement of the first signal, the average value of movement of the second signal, and the average value of movement of the third signal; and
a control unit configured to acquire a lap time or/and a split time when the posture determining unit determines that the posture of the instrument is a predetermined posture.
